(19) United States
(12) Patent Application Publication
(10) Pub. No.: US 2011/0291573 A1
(43) Pub. Date: Dec. 1, 2011

(54) RESONANT POWER SUPPLY FOR LIGHT-EMITTING DEVICES

(75) Inventor: KAN SHENG KUAN, HSINCHU (TW)

(73) Assignee: INERGY TECHNOLOGY INC., HSINCHU COUNTY (TW)

(21) Appl. No.: 12/789,022

(22) Filed: May 27, 2010

(51) Int. Cl. H05B 37/02

(52) U.S. Cl. 315/186; 315/224; 315/219

(57) ABSTRACT

A resonant power supply for light-emitting devices comprises an inverter including two DC input terminals and two AC output terminals, a resonant circuit connected in series to at least one of the two AC output terminals, and an LED circuit connected in series to the resonant circuit. The inverter is configured to convert a direct current from the two DC input terminals into an alternating current through the two AC output terminals, and the LED circuit emits lights as the alternating current is applied.

### BACKGROUND OF THE INVENTION

(A) Field of the Invention

The present invention relates to a resonant power supply for light-emitting devices, and more particularly, to a resonant power supply with an LC resonant circuit connecting an inverter and light-emitting devices in series.

(B) Description of the Related Art

With the recent advance of semiconductor device technology, light emitting diodes (LEDs) have come to have performance superior to that of incandescent lamps, in terms of the diversity of luminescent color, luminance, durability, and power consumption (luminous efficacy). Consequently, LED arrays are becoming more common in many applications as they are used to replace less efficient incandescent lamps. Status annunciators, message boards, liquid crystal display backing lights and traffic signals are common applications of LED arrays. In most of these uses, electrical power is obtained from AC source and some form of power supply converts the alternating line voltage to DC, or pulsing DC, to power the plurality of LEDs.

The electrical characteristics of LEDs are such that small changes in the voltage applied to the LED lamp will cause appreciable current changes. In addition, ambient temperature changes will also result in LED current changes by changing the forward drop across the LEDs. Furthermore, the lumen output of LEDs depends on the LED current. The existing electrical power supplies for LED light sources are not designed to precisely regulate the LED current to prevent luminous intensity variations due to variations in AC voltage input and ambient temperature. Operation of LED lamps at excessive forward current for a long period can cause unacceptable luminous intensity variations and even catastrophic failure. In addition, current electrical power supplies do not minimize power consumption to maximize energy savings.

### SUMMARY OF THE INVENTION

One aspect of the present invention provides a resonant power supply with an LC resonant circuit connecting an inverter and light-emitting devices in series.

A resonant power supply for light-emitting devices according to this aspect of the present invention comprises an inverter including two DC input terminals and two AC output terminals, a resonant circuit connected in series to at least one of the two AC output terminals, and an LED circuit connected in series to the resonant circuit. The inverter is configured to convert a direct current from the two DC input terminals into an alternating current through the two AC output terminals, and the LED circuit emits lights as the alternating current is applied.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 illustrates a resonant power supply for light-emitting devices according to one embodiment of the present invention;

FIG. 2 illustrates a resonant power supply for light-emitting devices according to a first embodiment of the present invention;

FIG. 3 illustrates a resonant power supply for light-emitting devices according to a second embodiment of the present invention;

FIG. 4 illustrates a resonant power supply for light-emitting devices according to a third embodiment of the present invention;

FIG. 5 illustrates a resonant power supply for light-emitting devices according to a fourth embodiment of the present invention;

FIG. 6 illustrates a resonant power supply for light-emitting devices according to a fifth embodiment of the present invention;

FIG. 7 illustrates a resonant power supply for light-emitting devices according to a sixth embodiment of the present invention;

FIG. 8 illustrates a resonant power supply for light-emitting devices according to a seventh embodiment of the present invention; and

FIG. 9 illustrates a resonant power supply for light-emitting devices according to an eighth embodiment of the present invention.

### DETAILED DESCRIPTION OF THE INVENTION

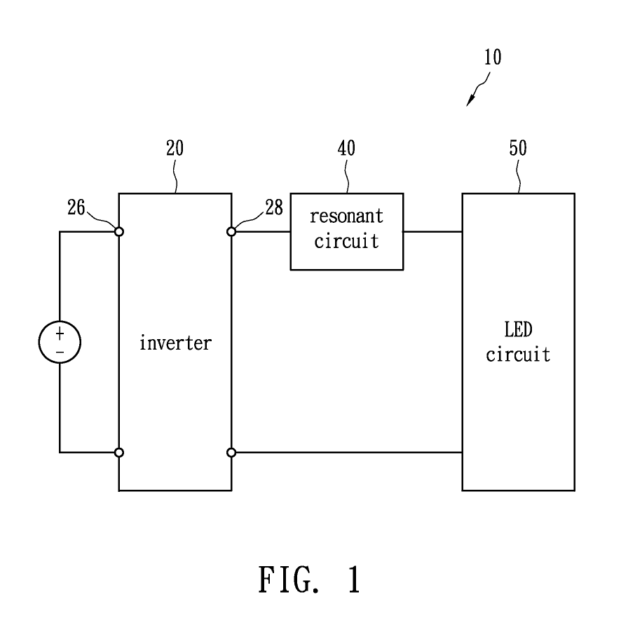

FIG. 1 illustrates a resonant power supply 10 for light-emitting devices according to one embodiment of the present invention. The resonant power supply 10 for light-emitting devices comprises an inverter 20 including two DC input terminals 26 and two AC output terminals 28, a resonant circuit 40 connected in series to at least one of the two AC output terminals 28, and an LED circuit 50 connected in series to the resonant circuit 40. The inverter 20 is configured to convert a direct current from the two DC input terminals 26 into an alternating current through the two AC output terminals 28, and the LED circuit 50 is configured to emit lights as the alternating current is applied.

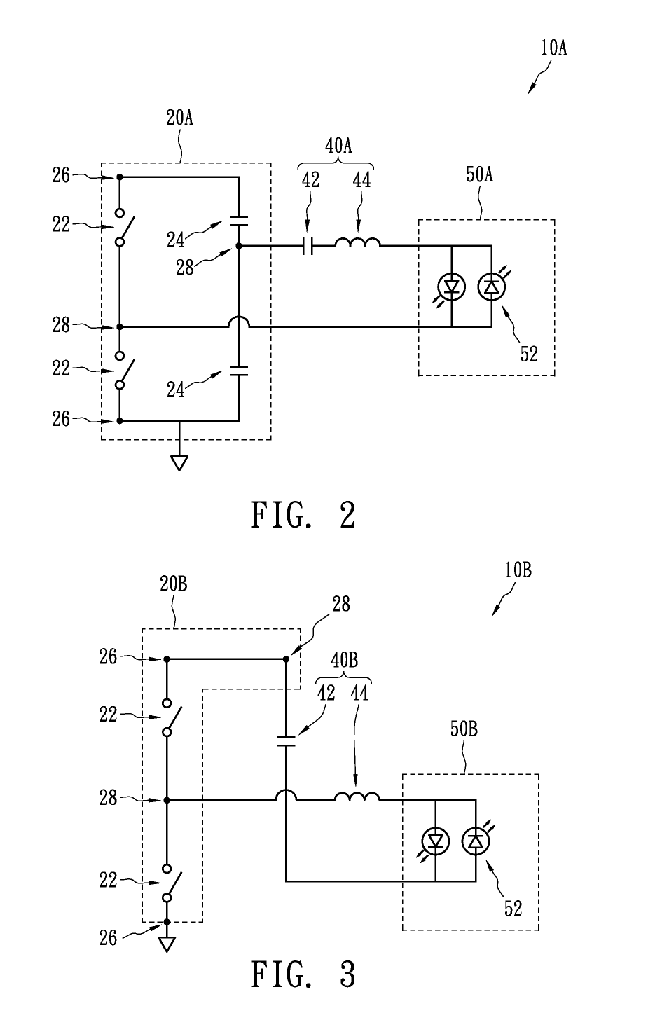

FIG. 2 illustrates a resonant power supply 10A for light-emitting devices according to a first embodiment of the present invention. The resonant power supply 10A comprises an inverter 20A including two DC input terminals 26 and two AC output terminals 28, a resonant circuit 40A connected in series to at least one of the two AC output terminals 28, and an LED circuit 50A connected in series to the resonant circuit 40A. In particular, the inverter 20A is configured to convert a direct current (DC) from the two DC input terminals 26 into an alternating current (AC) through the two AC output terminals 28, and the LED circuit 50A emit lights as the alternating current is applied.

The inverter 20A includes two serially connected switches 22 and two serially connected capacitors 24 between the two DC input terminals 26, and the two AC output terminals 28 are connected to two junctions between the two switches 22 and the two capacitors 24, respectively. The resonant circuit 40A includes a resonant capacitor 42 and a resonant inductor 44 connected between the LED circuit 50A and one of the two AC output terminals 28; for example, the junction between the two serially connected capacitors 24. The LED circuit 50A includes two anti-parallel series-connected light-emitting diodes 52 and is connected between the resonant circuit 40A and one of the two AC output terminals 28; for example, the junction between the two serially connected switches 22.

FIG. 3 illustrates a resonant power supply 10B for light-emitting devices according to a second embodiment of the present invention. The resonant power supply 10B comprises an inverter 20B, an LED circuit 50B and a resonant circuit 40B connecting the inverter 20B and the LED circuit 50B. The inverter 20B includes two serially connected switches 22 connected between the two DC input terminals 26, the junction between the two serially connected switches 22 serves as one of the two AC output terminal 28, and the other AC output terminal 28 connects the one of the two DC input terminals 26. In particular, the resonant circuit 40B includes a resonant capacitor 42 connected between the LED circuit 50A and one of the two AC output terminals 28 (for example, the AC output terminal 28 connected to one of the two DC input terminals 26) and a resonant inductor 44 connected between the LED circuit and the other AC output terminal 28 (for example, the junction between the two serially connected switches 22).

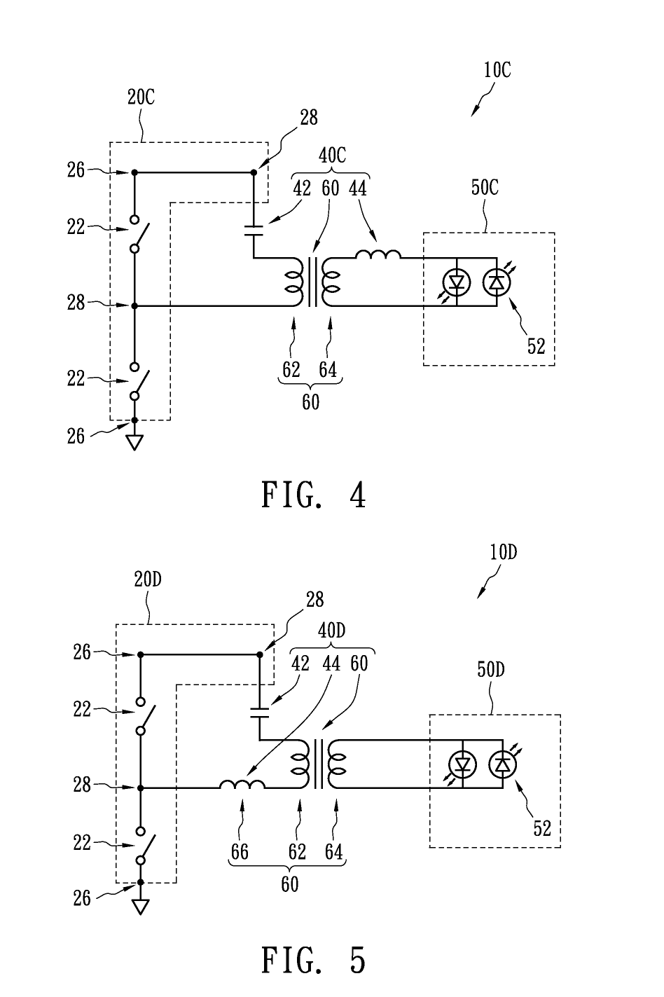

FIG. 4 illustrates a resonant power supply 10C for light-emitting devices according to a third embodiment of the present invention. The resonant power supply 10C comprises an inverter 20C, an LED circuit 50C and a resonant circuit 40C connecting the inverter 20C and the LED circuit 50C. Compared to the resonant circuit 40B in FIG. 3, the resonant circuit 40C in FIG. 4 includes a resonant capacitor 42, a resonant inductor 44, and a transformer 60 having a primary winding 62 and a secondary winding 64. The primary winding 62 is connected between the two AC output terminals 28 via the resonant capacitor 42, and the secondary winding 64 is connected to the LED circuit 50C. Furthermore, the resonant inductor 44 is connected between the secondary winding 64 of the transformer 60 and the LED circuit 50C.

FIG. 5 illustrates a resonant power supply 10D for light-emitting devices according to a fourth embodiment of the present invention. The resonant power supply 10D comprises an inverter 20D, an LED circuit 50D and a resonant circuit 40D connecting the inverter 20D and the LED circuit 50D. Compared to the resonant circuit 40C in FIG. 4 having the resonant inductor 44 between the secondary winding 64 of the transformer 60 and the LED circuit 50C, the resonant circuit 40D in FIG. 5 has the transformer 60 with a leakage inductance 66, which is used as the resonant inductor 44.

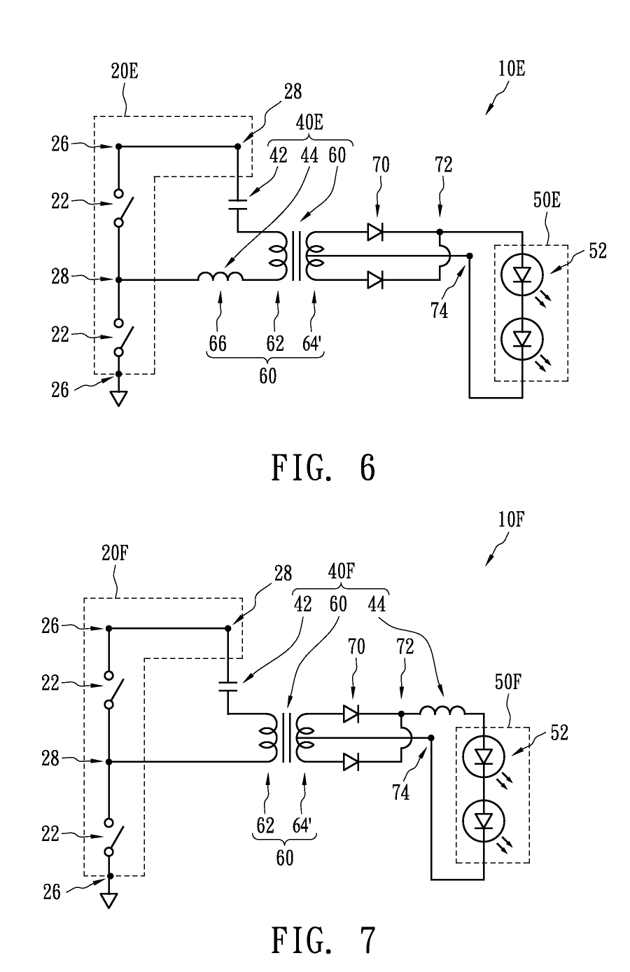

FIG. 6 illustrates a resonant power supply 10E for light-emitting devices according to a fifth embodiment of the present invention. The resonant power supply 10E comprises an inverter 20E, an LED circuit 50E and a resonant circuit 40E connecting the inverter 20E and the LED circuit 50E. The transformer 60 of the resonant power supply 10E comprises a primary winding 62 and a center tap secondary winding 64′. The primary winding 62 is connected to the two AC output terminals 28 via the resonant capacitor 42 and the resonant inductor 44, and the center tap secondary winding 64′ has two ends tied together through a diode 70 respectively to be a first output node 72 and a center tap end serving as a second output node 74. Furthermore, the LED circuit 50E includes two series-connected light-emitting diodes 52. In particular, the transformer 60 has a leakage inductance 66, which is used as the resonant inductor 44.

FIG. 7 illustrates a resonant power supply 10F for light-emitting devices according to a sixth embodiment of the present invention. The resonant power supply 10F comprises an inverter 20F, an LED circuit 50F and a resonant circuit 40F connecting the inverter 20F and the LED circuit 50F. Compared to the resonant circuit 40E in FIG. 6 using the leakage inductance 66 between the primary winding 62 and the AC output terminal 28 as the resonant inductor 44, the resonant circuit 40F in FIG. 7 further includes a resonant inductor 44 connected between the first output node 72 and the LED circuit 50F in case the leakage inductance of the transformer 60 is too small.

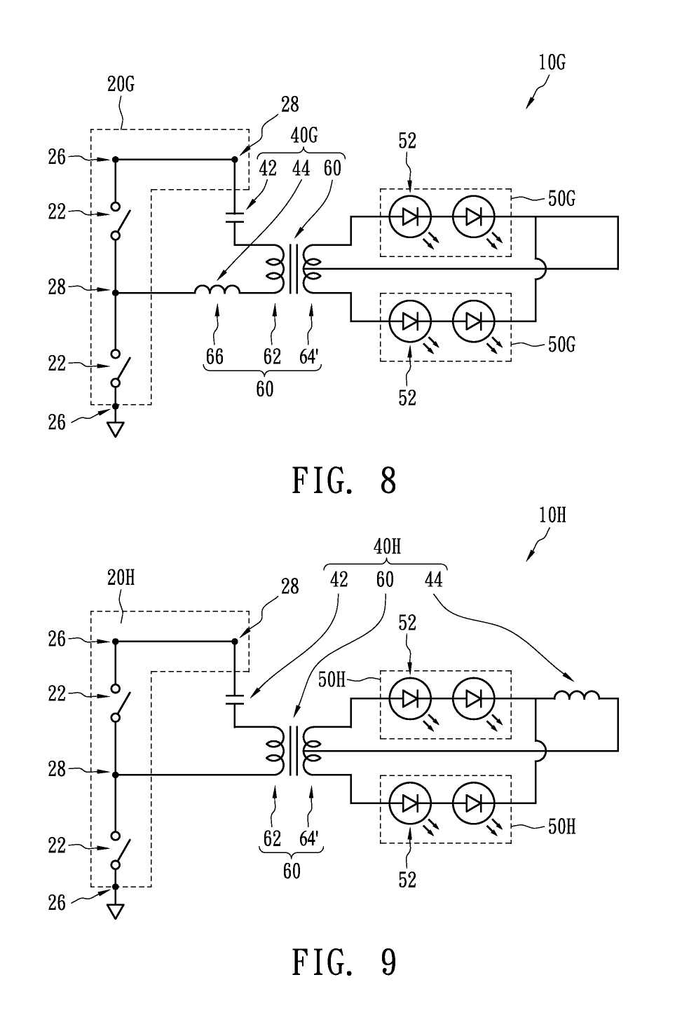

FIG. 8 illustrates a resonant power supply 10G for light-emitting devices according to a seventh embodiment of the present invention. The resonant power supply 10G comprises an inverter 20G, two LED circuits 50G and a resonant circuit 40G connecting the inverter 20G and the LED circuits 50G. In particular, the transformer 60 has a primary winding 62 and a center tap secondary winding 64′, and the two LED circuits 50G are connected to the secondary winding 64′ of the transformer 60 in a center-tapped manner. Furthermore, the transformer 60 has a leakage inductance 66, which is used as the resonant inductor 44.

FIG. 9 illustrates a resonant power supply 10H for light-emitting devices according to an eighth embodiment of the present invention. The resonant power supply 10H comprises an inverter 20H, two LED circuits 50H and a resonant circuit 40H connecting the inverter 20H and the LED circuits 50H. Compared to the resonant circuit 40G in FIG. 8, the resonant circuit 40H in FIG. 9 further includes a resonant inductor 44 connected between the center tap end of the secondary winding 64′ and the LED circuits 50H in case the leakage inductance of the transformer 60 is too small.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A resonant power supply for light-emitting devices, comprising:
an inverter including two DC input terminals and two AC output terminals, and configured to convert a direct current from the two DC input terminals into an alternating current through the two AC output terminals;
a resonant circuit connected in series to at least one of the two AC output terminals; and
an LED circuit connected in series to the resonant circuit, and configured to emit lights as the alternating current is applied.

2. The resonant power supply for light-emitting devices of claim 1, wherein the inverter includes two serially connected switches and two serially connected capacitors between the two DC input terminals, and the two AC output terminals are connected to two junctions between the two switches and the two capacitors.

3. The resonant power supply for light-emitting devices of claim 2, wherein the resonant circuit is connected between one of the two AC output terminals and the LED circuit.

4. The resonant power supply for light-emitting devices of claim 2, wherein the resonant circuit includes a capacitor and an inductor connected between one of the two AC output terminals and the LED circuit.

5. The resonant power supply for light-emitting devices of claim 2, wherein the LED circuit is connected between the resonant circuit and one of the two AC output terminals.

6. The resonant power supply for light-emitting devices of claim 1, wherein the inverter includes two serially connected switches connected between the two DC input terminals, one of the two AC output terminals connects one of the two DC input terminals, and the other AC output terminal connects one junction between the two switches.

7. The resonant power supply for light-emitting devices of claim 6, wherein the resonant circuit includes a capacitor connected between one of the two AC output terminals and the LED circuit and an inductor connected between the other AC output terminal and the LED circuit.

8. The resonant power supply for light-emitting devices of claim 6, wherein the resonant circuit includes a capacitor and a transformer having a primary winding connected between the two AC output terminals via the capacitor and a secondary winding connected to the LED circuit.

9. The resonant power supply for light-emitting devices of claim 8, wherein the transformer has a leakage inductance serving as an inductor of the resonant circuit.

10. The resonant power supply for light-emitting devices of claim 8, wherein the resonant circuit further includes an inductor connected between the secondary winding and the LED circuit.

11. The resonant power supply for light-emitting devices of claim 6, wherein the resonant circuit includes a capacitor and a transformer having a primary winding connected between the two AC output terminals via the capacitor and a center tap secondary winding, and the center tap secondary winding has two ends tied together through a diode respectively to be a first output node and a center tap end serving as a second output node.

12. The resonant power supply for light-emitting devices of claim 11, wherein the transformer has a leakage inductance serving as an inductor of the resonant circuit.

13. The resonant power supply for light-emitting devices of claim 11, wherein the resonant circuit further includes an inductor connected between the secondary winding and the LED circuit.

14. The resonant power supply for light-emitting devices of claim 1, wherein the LED circuit includes series-connected light-emitting diodes.

15. The resonant power supply for light-emitting devices of claim 1, wherein the LED circuit includes two anti-parallel series-connected light-emitting diodes.
